(19) United States
(12) Patent Application Publication
(10) Pub. No.: US 2013/0247837 A1
(43) Pub. Date: Sep. 26, 2013

(54) COLLAR APPARATUS FOR ANIMAL TRAINING WITH LENGTH ADJUSTABLE LEASH

(71) Applicant: Min Jae SO, Seoul (KR)

(72) Inventor: Min Jae SO, Seoul (KR)

(73) Assignee: DOGTRA CO., LTD., Incheon (KR)

(21) Appl. No.: 13/487,602

(22) Filed: Jun. 4, 2012

(30) Foreign Application Priority Data
Mar. 20, 2012 (KR) 10-2012-0028426

(51) Int. Cl. A01K 27/00; A01K 15/02; A01K 15/00

(52) U.S. Cl. 119/719; 119/859; 119/720

(57) ABSTRACT

Disclosed is a collar apparatus for animal training with a length adjustable leash. The collar apparatus applies a vibration or an electrical stimulation to an animal while automatically adjusting a length of a leash connected to an animal's body. Accordingly, it is possible to train the animal to desirably act by applying the electrical stimulation or the vibration to the animal through adjusting the length of the leash connected to the animal's body when the animal acts with undesirable behavior.

### BACKGROUND OF THE INVENTION

1. Field of the Invention

The present invention relates to a collar apparatus for animal training with a length adjustable leash, and more particularly to a collar apparatus for animal training which can train an animal to act in a desirable manner by mechanically adjusting a length of a leash connected to an animal's body and applying a vibration or an electrical stimulation to the animal to control the animal.

2. Description of the Prior Art

Recently, with the improvement of the quality of life, the number of households considering animals such as a dog, a cat and the like as a family member is continuously increased and thus pet related businesses are steadily increased.

Accordingly, various animal products having good quality, for example, a dye and a leash or a collar connected to an animal's body as well as food for animals have been released.

Among such a product targeting animals, a leash is connected to the animal's body in order to enable a master to easily control the animal when they go out for a walk. The leash is used as a means for controlling such that the animal acts within a range of activity and preventing the animal from escaping.

However, in the conventional arts, it is difficult to automatically adjust the leash for controlling the range of activity of the animal so that a master of the animal experiences inconvenience.

Further, when an animal injures other people while taking a walk, the master also experiences inconvenience since there is no method of controlling the animal.

Accordingly, it is required to provide an apparatus which, when the animal acts with undesirable behavior such as barking and the like, enables the animal to recognize the undesirable behavior and trains the animal to desirably act by applying an electrical stimulation or a vibration to the animal through adjusting a length of the leash connected to the animal's body.

### SUMMARY OF THE INVENTION

Accordingly, the present invention has been made to solve the above-mentioned problems occurring in the prior art, and the present invention provides a collar apparatus for animal training with a length adjustable leash which, when the animal acts an undesirable behavior, can applies a vibration or an electrical stimulation to an animal to make the animal desirable act while automatically adjusting a length of the leash connected to the animal's body.

Further, the present invention provides a collar apparatus for animal training with a length adjustable leash which can wirelessly control an operation of an electrical stimulation or a vibration when the electrical stimulation or the vibration is applied to the animal to make the animal desirably act.

In accordance with an aspect of the present invention, there is provided a collar apparatus for animal training with a length adjustable leash, the collar apparatus including a body for wirelessly transferring a vibration generating command or an electrical stimulation generating command and a vibration intensity command or an electrical stimulation intensity command to a collar worn on an animal's body, the body including a length adjustable leash connected to the animal's body; and the collar for receiving the vibration generating command or the electrical stimulation generating command and the vibration intensity command or the electrical stimulation intensity command from the body and generating a vibration or an electrical stimulation having an intensity according to a corresponding command.

The body may include a key input unit comprising a leash length adjusting key for adjusting a leash length, a vibration generating key for generating the vibration, an electrical stimulation generating key for generating the electrical stimulation, and an intensity adjusting key for adjusting a vibration intensity or an electrical stimulation intensity; a leash length adjustor for fixing the length of the leash connected to the animal's body according to an input of the leash length adjusting key; a body storage unit for storing a vibration generating command code according to an input of the vibration generating key, an electrical stimulation generating command code according to an input of the electrical stimulation generating key, a vibration intensity command code or an electrical stimulation intensity command code according to an input of the intensity adjusting key, and a device identification code; a controller for extracting a vibration command code or an electrical stimulation command code and a vibration intensity command code or an electrical stimulation intensity command code corresponding to a key input from the key input unit, extracting the device identification code, and generating transmission data; and a transmitter for transmitting the transmission data generated through the controller.

The intensity adjusting key may include a volume key.

The collar may include a vibration generator for generating the vibration while being in contact with the animal's body; an electrical stimulation generator for generating the electrical stimulation while being in contact with the animal's body; a receiver for receiving the transmission data; and a collar controller for analyzing the transmission data and controlling the vibration generator and the electrical stimulation generator such that the vibration or the electrical stimulation having the intensity according to the corresponding command is generated.

### BRIEF DESCRIPTION OF THE DRAWINGS

FIG. 1 is a perspective view of a collar apparatus for animal training with a length adjustable leash according to embodiments of the present invention,

FIG. 2 is a block diagram of an inter construction of the collar apparatus for animal training with a length adjustable leash according to embodiments of the present invention,

FIG. 3 is a flowchart of a process of generating transmission data for controlling activity of the animal in the collar apparatus for animal training with a length adjustable leash according to embodiments of the present invention, and

FIG. 4 illustrates a construction of transmission data according to embodiments of the present invention.

### DETAILED DESCRIPTION OF THE EXEMPLARY EMBODIMENTS

Hereinafter, an exemplary embodiment of the present invention will be described with reference to the accompanying drawings. In the following description and drawings, the same reference numerals are used to designate the same or similar components, and so repetition of the description on the same or similar components will be omitted.

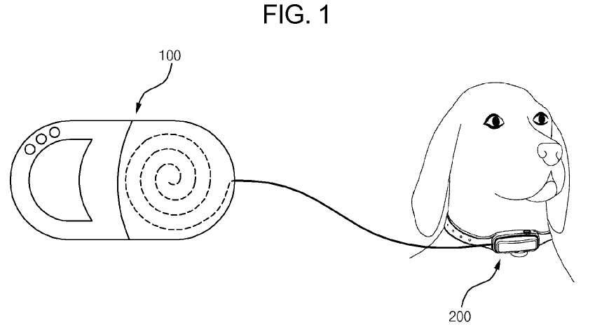

FIG. 1 is a perspective view of a collar apparatus for animal training with a length adjustable leash according to embodiments of the present invention.

As shown in FIG. 1, the collar apparatus for animal training with the length adjustable leash includes a body 100 for wirelessly transferring a vibration or an electrical stimulation generating command to the collar connected to an animal's body while automatically adjusting the length of the leash connected to the animal's body in order to easily control the animal based on its range of activity and a collar 200 for generating a vibration or an electrical stimulation according to the command transferred from the body 100 connected to the animal's body.

Although it is assumed in embodiments of the present invention that the collar 200 is wore on an animal's neck, it goes without saying that the collar 200 can be connected to any part such as a body or a foot of the animal instead of the neck.

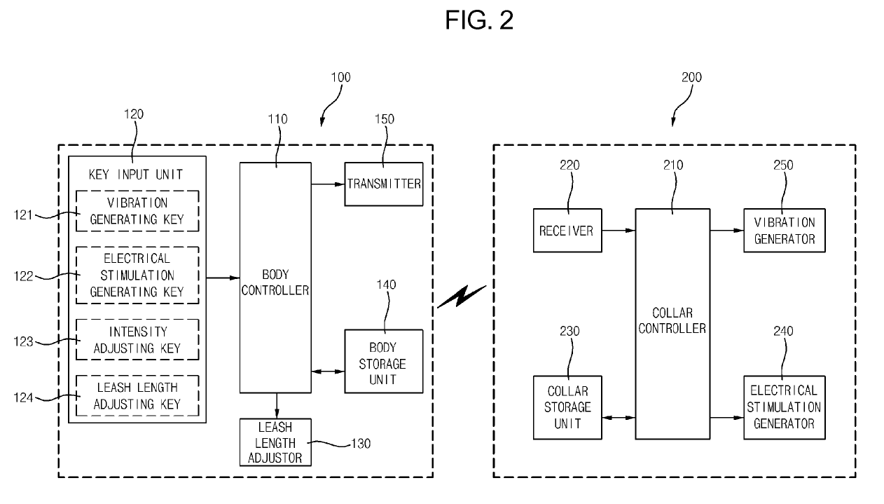

FIG. 2 is a block diagram of an inter construction of the collar apparatus for animal training with a length adjustable leash according to embodiments of the present invention.

The body 100 includes a body controller 110, a key input unit 120, a leash length adjustor 130, a body storage unit 140, a transmitter 150, and a battery (not shown).

The key input unit 120 includes a vibration generating key 121 for making vibration generated in the collar 200 connected to the animal's body, an electrical stimulation generating key 122 for making an electrical stimulation generated in the collar 200 connected to the animal's body, an intensity adjusting key 123 for adjusting an intensity of the vibration or the electrical stimulation, and a leash length adjusting key 124 for automatically adjusting a length of the leash connected to the animal's body.

At this time, the intensity adjusting key 123 may include a volume key. The leash length adjusting key 124 includes a lever for fixing the leash length. When the leash length adjusting key 124 is moved forwardly, an adjustment of the leash length is impossible. When the leash length adjusting key 124 is moved backwardly, the adjustment of the leash length is possible.

Further, although it has been described in embodiments of the present invention that the electrical stimulation generating key 122 is implemented as one key, the electrical stimulation generating key 122 can be implemented as two keys including a high electrical stimulation generating key and a low electrical stimulation generating key.

The leash length adjustor 130 has a leash therein, and the leash length is automatically adjusted in accordance with activity of the animal. Further, the leash length is fixed or adjusted according to an input of the leash length adjusting key 124.

The body storage unit 140 stores a command code of each key included in the key input unit 120, and stores an identification code for identifying the body 100.

At this time, the command code of each key may be a code according to a vibration generating command, a code according to an electrical stimulation generating command, and a code for indicating intensities of the vibration and the electrical stimulation.

The transmitter 150 transfers transmission data according to the vibration generating command or the electrical stimulation generating command to the collar 200.

The body controller 110 controls a general operation of the body 100, extracts an intensity command code according to an input of the intensity adjusting key 123 when the intensity adjusting key 123 is input, and extracts the vibration generating command code or the electrical stimulation generating command code when the vibration generating key 121 or the electrical stimulation generating key 122 is input.

Further, the body controller 110 extracts the identification code of the body 100, generates the transmission data by using the vibration generating command code or the electrical stimulation generating command code and the identification code of the body 100, and then transfers the generated transmission data to the collar 200.

The collar 200 includes a collar controller 210, a receiver 220, a collar storage unit 230, an electrical stimulation generator 240, a vibration generator 250, and a battery (not shown).

The receiver 220 receives the transmission data from the transmitter 150 of the body 100.

The collar storage unit 230 stores the identification code of the body 100.

The electrical stimulation generator 240 includes a pair of electric shock terminals in contact with the animal's body, and adjusts an intensity of an electricity (voltage or current) flowing through the electric shocks under a control of the controller 210.

The vibration generator 250 includes a sensor for generating a vibration while being in contact with the animal's body, and generates the vibration while adjusting an intensity of the vibration under the control of the controller 210.

The collar controller 210 controls a general operation of the collar 200, and analyzes the transmission data received through the receiver 220.

Further, when it is determined that an identification code contained in the transmission data is the identification code of the body 100, the collar controller 210 analyzes the intensity command code, the vibration generating command code, or the electrical stimulation generating command code, and controls such that the vibration or the electrical stimulation is generated based on an intensity according to the intensity command code.

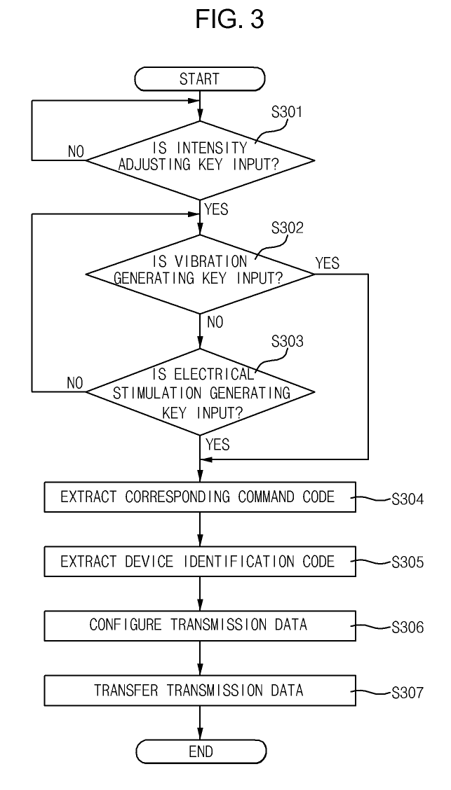

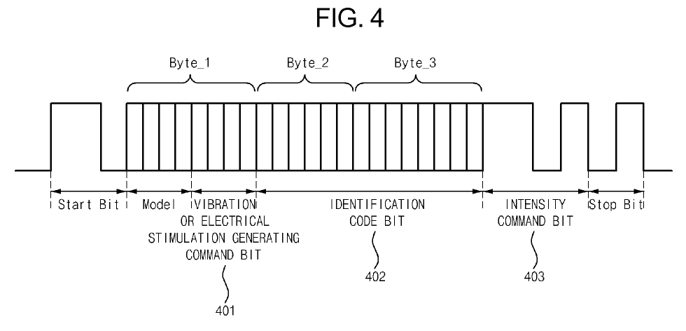

FIG. 3 is a flowchart of a process of generating transmission data for controlling activity of the animal in the collar apparatus for animal training with a length adjustable leash according to embodiments of the present invention, and FIG. 4 illustrates a configuration of transmission data according to embodiments of the present invention.

Referring to FIGS. 3 and 4, the body 100 determines an intensity of the vibration or the electrical stimulation, that is, an intensity level when the intensity adjusting key 123 is input in step S301, and extracts the vibration generating command code and the command code for the vibration intensity in step S304 when the vibration generating key 121 is input in step S302.

Further, the body 100 extracts the identification code of the body 100 in step S305, and configures the transmission data by using the vibration generating command code, the vibration intensity command code, and the identification code of the body 100.

At this time, the generated transmission data is as shown in FIG. 4, and includes a start bit indicating a start of a frame of the transmission data, a vibration generating command bit 401 indicating the vibration generating command code, an identification code bit 402 indicating the identification code of the body 100, an intensity command bit 403 indicating the vibration intensity command code, and a stop bit indicating an end of the frame of the transmission data.

When the transmission data having the aforementioned configuration is generated, the body 100 transfers the generated transmission data to the collar 200 in step S307.

However, the body 100 does not receive the input of the vibration generating key 121 in step S302, and determines whether the electrical stimulation generating key 122 is input in step S303.

Further, when it is determined that the electrical stimulation generating key 122 is input, the body 100 extracts the electrical stimulation generating command code and the command code for the electrical stimulation intensity in step S304.

Furthermore, the body 100 extracts the identification code of the body 100 in step S305, and configures the transmission data by using the electrical stimulation generating command code, the electrical stimulation intensity command code, and the identification code of the body 100 in step S306.

At this time, the generated transmission data is as shown in FIG. 4, and includes a start bit indicating a start of a frame of the transmission data, a vibration generating command bit 401 indicating the vibration generating command code, an identification code bit 402 indicating the identification code of the body 100, an intensity command bit 403 indicating the vibration intensity command code, and a stop bit indicating an end of the frame of the transmission data.

When the transmission data having the aforementioned configuration is generated, the body 100 transfers the generated transmission data to the collar 200 in step S307.

Thereafter, the collar 200 generates the vibration or the electrical stimulation having a corresponding intensity according to the transmission data transmitted from the body 100.

Accordingly, the master can train the animal to act in a desirable manner by wirelessly applying the vibration or the electrical stimulation to the animal while automatically adjusting the length of the leash in accordance with the range of activity of the animal when the animal acts with undesirable behavior.

Therefore, the present invention has an effect of training an animal to act in a desirable manner by automatically adjusting a length of a leash connected to a body of the animal when the animal acts an undesirable behavior.

Further, the present invention has an effect of wirelessly controlling an operation of a vibration or an electrical stimulation when applying the vibration or the electrical stimulation to the animal to make the animal act in a desirable manner.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A collar apparatus for animal training with a length adjustable leash, the collar apparatus comprising:
a body for wirelessly transferring a vibration generating command or an electrical stimulation generating command and a vibration intensity command or an electrical stimulation intensity command to a collar worn on an animal's body, the body comprising a length adjustable leash connected to the animal's body; and
the collar for receiving the vibration generating command or the electrical stimulation generating command and the vibration intensity command or the electrical stimulation intensity command from the body and generating a vibration or an electrical stimulation having an intensity according to a corresponding command.

2. The collar apparatus as claimed in claim 1, wherein the body comprises:
a key input unit comprising a leash length adjusting key for adjusting a leash length, a vibration generating key for generating the vibration, an electrical stimulation generating key for generating the electrical stimulation, and an intensity adjusting key for adjusting a vibration intensity or an electrical stimulation intensity;
a leash length adjustor for fixing the length of the leash connected to the animal's body according to an input of the leash length adjusting key;
a body storage unit for storing a vibration generating command code according to an input of the vibration generating key, an electrical stimulation generating command code according to an input of the electrical stimulation generating key, a vibration intensity command code or an electrical stimulation intensity command code according to an input of the intensity adjusting key, and a device identification code;
a controller for extracting a vibration command code or an electrical stimulation command code and a vibration intensity command code or an electrical stimulation intensity command code corresponding to a key input from the key input unit, extracting the device identification code, and generating transmission data; and
a transmitter for transmitting the transmission data generated through the controller.

3. The collar apparatus as claimed in claim 2, wherein the intensity adjusting key comprises a volume key.

4. The collar apparatus as claimed in claim 2, wherein the collar comprises:
a vibration generator for generating the vibration while being in contact with the animal's body;
an electrical stimulation generator for generating the electrical stimulation while being in contact with the animal's body;
a receiver for receiving the transmission data; and
a collar controller for analyzing the transmission data and controlling the vibration generator and the electrical stimulation generator such that the vibration or the electrical stimulation having the intensity according to the corresponding command is generated.
